(19) United States
(12) Patent Application Publication
(10) Pub. No.: US 2015/0206263 A1
(43) Pub. Date: Jul. 23, 2015

(54) JURISDICTION MODELING EMPLOYING CROSS SYSTEM DEPENDENCIES

(71) Applicant: International Business Machines Corporation, Armonk, NY (US)

(72) Inventors: Anthony L. Carrato, New Milford, CT (US); John M. Cohn, Richmond, VT (US); Colin G. Harrison, Brookfield, CT (US); John Hogan, Stone Ridge, NY (US); Norishige Morimoto, Tokyo (JP); Robert J. Schloss, Briarcliff Manor, NY (US); Trinette A. Surles, Houston, TX (US); Hideo Watanabe, Tokyo (JP); Peter Williams, Danville, CA (US)

(73) Assignee: International Business Machines Corporation, Armonk, NY (US)

(21) Appl. No.: 14/158,778

(22) Filed: Jan. 18, 2014

(51) Int. Cl. G06Q 50/26; G06F 17/50; G06Q 10/06

(52) U.S. Cl. CPC G06Q 50/26; G06Q 10/067; G06F 17/50

(57) ABSTRACT

A method of modeling a jurisdiction provides jurisdiction resilience information and jurisdiction impact information. The method models a jurisdiction system by determining the multiple different systems present in a particular jurisdiction. The method determines the assets of the multiple different systems and stores asset information describing the respective assets of the multiple different systems in a jurisdiction meta-model. The method may determine critical paths across the different systems of the jurisdiction and identify those critical paths across different systems in the jurisdiction meta-model. The method may also determine cascading effects of incidents to assets within each system and identify those cascading effects within each system in the jurisdiction meta-model. The method may also determine cross-cascading effects of incidents to assets across different systems of the jurisdiction and identifying those cross-cascading effects in the jurisdiction meta-model.

### BACKGROUND

The disclosures herein relate generally to information handling systems (IHSs), and more particularly, to IHSs that monitor, process and model jurisdictions such as cities, towns, counties or other jurisdictions that are subject to incidents that impact the operations thereof.

### BRIEF SUMMARY

In one embodiment, a method of modeling a jurisdiction is disclosed. The method may include determining multiple different systems within the jurisdiction. For example, a city jurisdiction may include a water system, an electric system, a traffic system as well as other different systems. The method may also include determining assets of the multiple different systems. The method may further include storing, in a jurisdiction meta-model, asset information describing the respective assets of the multiple different systems. The method may still further include determining critical paths across the different systems of the jurisdiction and identifying those critical paths across different systems in the jurisdiction meta-model. The method may also include determining cascading effects of incidents to assets within each system and identifying those cascading effects within each system in the jurisdiction meta-model. The method may also include determining cross-cascading effects of incidents to assets across different systems of the jurisdiction and identifying those cross-cascading effects in the jurisdiction meta-model.

In another embodiment, an information handling system (IHS) is disclosed that includes a processor. The IHS also includes a system memory coupled to the processor. In one embodiment, the system memory may be configured to determine multiple different systems of a jurisdiction. The system memory may also be configured to determine assets of the multiple different systems. The system memory may further be configured to store, in a jurisdiction meta-model, asset information describing the respective assets of the multiple different systems. The system memory may be still further configured to determine critical paths across the different systems of the jurisdiction and identify those critical paths across different systems in the jurisdiction meta-model. The system memory may also be configured to determine cascading effects of incidents to assets within each system and identify those cascading effects within each system in the jurisdiction meta-model. The system memory may also be configured to determine cross-cascading effects of incidents to assets across different systems of the jurisdiction and identify those cross-cascading effects in the jurisdiction meta-model.

In yet another embodiment, a computer program product is disclosed that includes a non-transitory computer readable storage medium. The computer program product may include first instructions that determine multiple different systems of a jurisdiction. The computer program product may also include second instructions that determine assets of the multiple different systems. The computer program product may further include third instructions that store, in a jurisdiction meta-model, asset information describing the respective assets of the multiple different systems. The computer program product may still further include fourth instructions that determine critical paths across the different systems of the jurisdiction and that identify those critical paths across different systems in the jurisdiction meta-model. The computer program product may also include fifth instructions that determine cascading effects of incidents to assets within each system and that identify those cascading effects within each system in the jurisdiction meta-model. The computer program product may further include sixth instructions that determine cross-cascading effects of incidents to assets across different systems of the jurisdiction and that identify those cross-cascading effects in the jurisdiction meta-model. The first, second, third, fourth, fifth and sixth instructions are stored on the non-transitory computer readable storage medium.

### BRIEF DESCRIPTION OF THE DRAWINGS

The appended drawings illustrate only exemplary embodiments of the invention and therefore do not limit its scope because the inventive concepts lend themselves to other equally effective embodiments.

FIG. 1A is a simplified representation of a jurisdiction such as a city, village or county which may employ the disclosed methodology.

FIG. 1B is a is a representation a jurisdiction system including multiple systems that employ the disclosed methodology.

FIG. 2A is the first of four quadrants of a representation of the meta-model that the disclosed methodology employs.

FIG. 2B is the second of four quadrants of a representation of the meta-model that the disclosed methodology employs.

FIG. 2C is the third of four quadrants of a representation of the meta-model that the disclosed methodology employs.

FIG. 2D is the fourth of four quadrants of a representation of the meta-model that the disclosed methodology employs.

FIG. 3 is an information handling system (IHS) configured to practice the disclosed methodology.

### DETAILED DESCRIPTION

In contemporary times, jurisdictions such as cities have become increasingly complex due to demographic, technological and sociological changes. The population densities of city jurisdictions have generally increased. For these and for other reasons, governments have been faced with increasing numbers and severities of incidents, i.e, events, to which they need to respond. In one embodiment, the disclosed methodology may be useful in reducing the risk of cities to incidents and in increasing the resilience of cities to those incidents.

Modern cities and other jurisdictions may include a system of systems. For example, a jurisdiction system such as a city may include a water utility system, an electrical utility system, a hospital system, a traffic management system and other systems. The disclosed methodology considers the relationships, contexts, and management of city systems more completely than other methods. Failure of a particular system (for example, loss of electrical power) may be problematic, but where such a failure interacts with other systems such as water treatment, traffic management, and healthcare for example, the effects may be greatly magnified as they “cascade” both spatially (more areas affected) and functionally (more systems affected). To manage such cascading risks, the disclosed methodology quantifies the relationships between city systems. The disclosed methodology uses these relationships to understand when an incident may occur (i.e. prediction), the likelihood of such an event (i.e. risk), where the incident may occur (incident area), the effects the incident may produce (propagation and impact), and possible remedial action to prevent or react to the incident (resilience).

City systems tend to be very complex and often include large geographic areas. City systems are exposed to unpredictable forces such as environmental and human factors. Moreover, city systems may include interrelationships among subsystems where those interrelationships among subsystems may not be easily understood. Further complicating matters, city systems may involve overlapping areas of ownership and responsibility.

In one embodiment, a system of systems is disclosed that includes a meta-model that provides a resilience score for a city, town, county or other jurisdiction with respect to incidents that occur in that jurisdiction, or that may occur in that jurisdiction. In one embodiment, the disclosed method may provide for detecting, defining, and visualizing system relationships that impact the risk of different types of incidents in urban areas. The disclosed method may provide tooling for the definition of these relationships. The disclosed method may also aid in both the manual and auto-discovery of the risk relationships. Relationships may be categorized by function, fault dependency, and/or spatial proximity.

The disclosed methodology employs a jurisdiction system meta-model that visualizes a city as a system of systems and that describes how city systems interact and intersect one another. The disclosed methodology visualizes city systems and their operating contexts, risks, sensitivities, and costs. In one embodiment, the disclosed methodology may be used during development and maintenance of meta-models. In another embodiment, the disclosed methodology may be used in real-time for standard operational coordination, scenario analysis during incidents and for historical data mining. The disclosed methodology may provide auto-discovery of relationships of systems in a city using crowd-sourcing, event management and other techniques. In one embodiment, the disclosed methodology may provide a shared central repository of captured sub-models of already known systems within the city system including the associated sensitivities, risks, costs and dependencies of such systems within the city. The disclosed methodology may hierarchically reuse captured sub-models for a given set of systems. For example, if a model for the cascading cost of a major traffic stoppage existed, it may be reused to develop a new model of weather impacts which also happen to impact traffic. In one embodiment, the disclosed methodology may provide a set of reusable subsystem templates based on extended unified modeling language (UML) that may be applied in a new system within a city system. For example, the method may employ a model for power outage that includes the suggested inter-dependency models that relate power loss to problems with both water pumping in a water utility system and traffic signals in a traffic management system. A user may then personalize these templates for the given system by adding/deleting new interdependencies and assigning appropriate risks and coasts to each.

In one embodiment, the disclosed methodology may provide data capture and storage for the results of the above analysis, for each individual asset. Assets may be grouped; for example, all streetlights or traffic signals on a given power circuit may be one asset group. The disclosed methodology may provide for reusing pre-captured sub-patterns to speed up creation of a new model. These sub-patterns may be reused as is, or may be modified for use. The modified instance of the sub-pattern model may then optionally be stored for subsequent reuse.

The disclosed methodology may display critical infrastructure assets by geographical location such as by employing linear asset segments. The methodology may map and display the relationships and dependencies identified between each asset. The methodology may enable any one asset, or group thereof, to be selected either arbitrarily, or by inclusion within a polygon (for example defining a flood zone and depth), and identifying the cascading impacts of those assets' failure to be displayed on a user's display along with pre-assigned probabilities and impacts (accumulated risks). The display may show the geographical location of the impact, with mouse-over text or other notation of that impact and its severity.

In one embodiment, the disclosed methodology may display a cascade of second-order impacts to be shown geographically, again with accumulated probabilities and impacts (accumulated risk). For example, such a cascade graphically shows the user that the loss of electrical power at a particular substation may affect a different city system, such as the traffic management system. The methodology may display an extended “fault tree” that shows the “root cause” of the cascade and intermediate stages. The disclosed methodology may enable the impact of ad hoc events to be monitored, for example by displaying those assets that employ a diesel fuel back-up and that would thus be affected by a fuel shortage. The method may propose priorities for remedial action based on logical impact sequence and the accumulation of the pre-assigned severity throughout the cascade. This feature may be useful for either long-term planning or in a direct emergency management scenario.

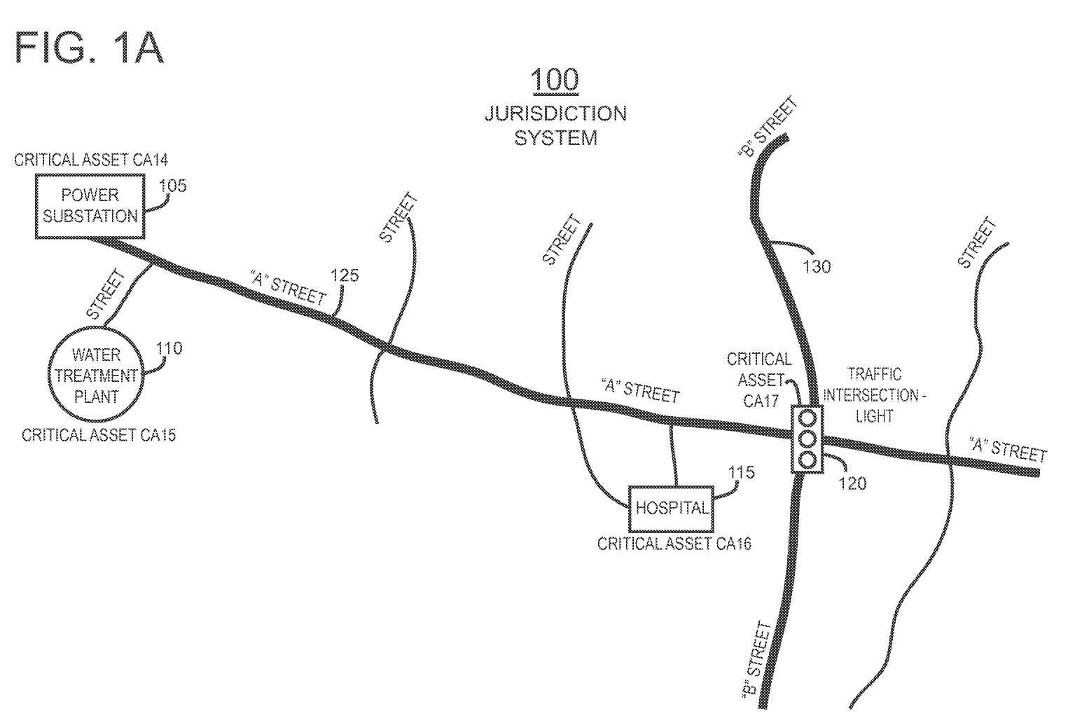

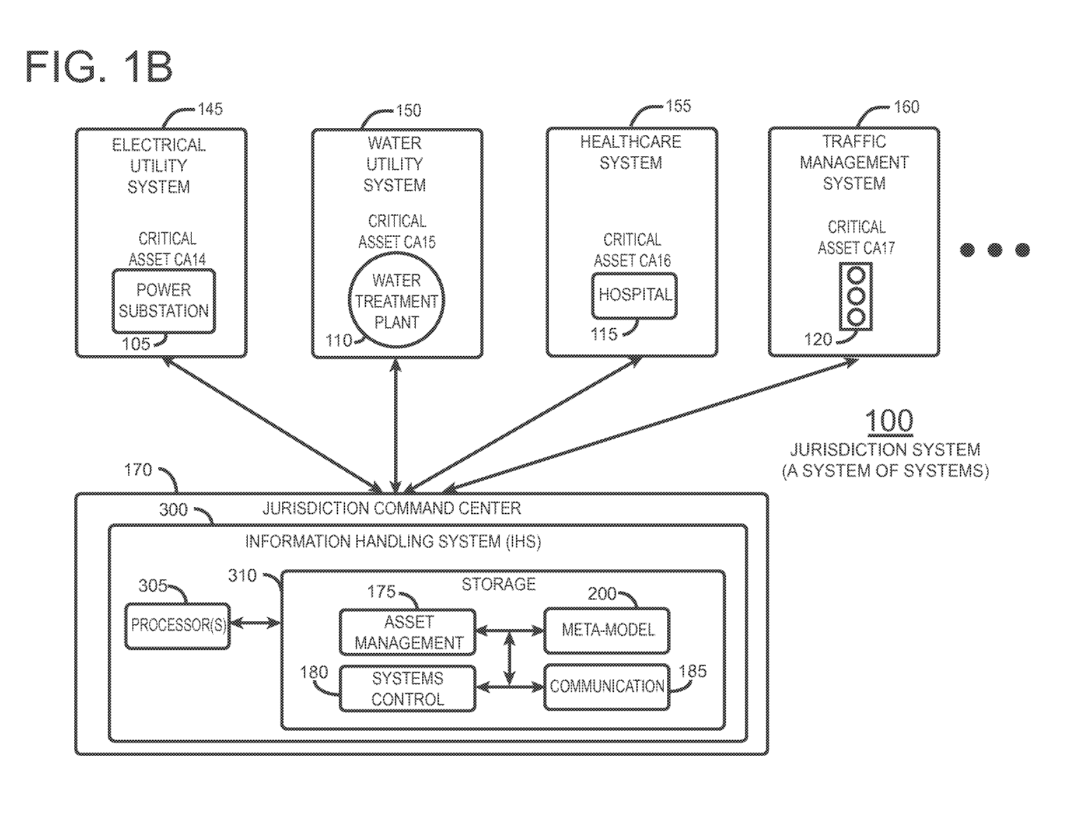

FIG. 1A is a simplified representation of a jurisdiction system such as a city, village or county. For discussion purposes, FIG. 1A shows a city jurisdiction that is in practice a system of systems that will be referred to as jurisdiction system 100. In this particular example, jurisdiction system 100 includes a power substation 105, a water treatment plant 110, a hospital 115 and a traffic light 120 at a critical intersection of “A” street 125 and B street 130. In this simplified representation, power substation 105 a part of an electrical utility system that supplies power for the entire jurisdiction. In this respect, power substation 105 may be considered to be a subsystem of the electrical utility system. Other subsystems of the electrical utility system may include other power substations, generating plants and power distribution lines for example. In a similar manner, water treatment plant 110 is part of a water utility system that may include other subsystems such as other water treatment plants, channels, sewers, floodgates and weirs for example. Hospital 115 may be part of a larger multi-hospital, multi-clinic health care system. Traffic light 120 is part of a traffic management system of the jurisdiction. Each of the above subsystems, namely power substation 105, water treatment plant 110, hospital 115 and traffic light 120 may be or include one or more critical assets. For example, power substation includes a critical asset CA14, water treatment plant 110 includes a critical asset CA15, hospital 115 includes a critical asset CA16 and traffic light 120 is a critical asset CA17 of the traffic management system.

FIG. 1B provides additional detail with respect to the representative jurisdiction system 100 of FIG. 1A. In this particular embodiment, jurisdiction system 100 includes an electrical utility system 145 that includes power substation 105 (critical asset CA14). Jurisdiction system 100 also includes a water utility system 150 that includes water treatment plant 110 (critical asset CA15). In this particular embodiment, jurisdiction system 100 further includes healthcare system 155 that includes hospital 115 (critical asset CA16). Jurisdiction system 100 also includes a traffic management system 160 that includes traffic light 120 (critical asset CA17). The ellipses to the right of traffic system 160 indicate that jurisdiction system 100 may include still other systems not specifically shown, for example fuel storage systems, sanitation systems, snow removal systems, communication systems as well as other systems.

Jurisdiction system 100 includes a jurisdiction command center 170 in which one or more information handling systems (IHSs) 300 may be installed to facilitate monitoring of systems 145-160, control of systems 145-160, prediction of incidents in systems 145-160, and response by jurisdiction system 100 to incidents that occur in systems 145-160 thereof. The particular topology of jurisdiction command center 170 may take many different forms in addition to the particular arrangement that FIG. 1B depicts. Some components of jurisdiction command center 170 may be integrated together at one location or spread over two or more locations as desired.

In this particular embodiment, jurisdiction command center 170 includes an information handling system (IHS) 300 that includes one or more processors 305 that couple to storage 310. Storage 310 includes an asset management package 175, a systems control package 180, a communication package 185 and a jurisdiction meta-model 200 which may communicate with one another as indicated by the arrows in storage 310. In one embodiment, asset management package 175, systems control package 180, communication package 185 and meta-model 200 may be implemented in software. In one embodiment, asset management package 175 may be located at a physically separate location different from the location of system control package 180. Asset management package 175 and systems control package 180 each may include software that resides on physically different IHSs. However, for ease of illustration, asset management package 175 and systems control package 180 are shown in the same IHS in FIG. 1B.

Asset management package 175 monitors the myriad assets of the multiple systems that form jurisdiction system 100. As shown in FIG. 1B, electrical utility system 145, water utility system 150, healthcare system 155 and traffic management system 160 each include multiple respective assets. Asset management package 175 is an asset manager that collects and stores information about each of the assets of systems 145-160, as discussed in more detail below. Asset management package 175 operates in cooperation with meta-model 200. Meta-model 200 provides a model of the assets, and the interaction of the assets, that form electrical utility system 145, water utility system 150, healthcare system 155 and traffic measured system 160. Meta-model 200 stores information that represents the cross-functional dependencies exhibited by the assets of the four different systems 145-160. One example of such a cross system functional dependency and a cascading failure is the case where an auto-recloser switch asset fails at power substation 105. The auto-recloser switch failure causes multiple transformer assets to overload and shut down power substation 105. The electrical failure at power substation 105 causes traffic light asset 122 to malfunction and causes a traffic jam that delays ambulances reaching hospital 115.

Communication package 185 provides communication of sensed information from electrical utility system 145, water utility system 150, healthcare system 155, and traffic management system 160 to asset management package 175, to systems control package 180 and to meta-model 200, and vice versa. Such information may include sensed status information with respect to all of the assets of systems 145-160. In this manner, systems 145-160 may inform asset management package 175 and systems control package 180 of the current status of assets including critical assets which are pre-identified prior to the occurrence of an incident.

System control package 180 in cooperation with asset management package 175 and meta-model 200 may send control information to systems 145-160 to instruct those systems with respect to an appropriate response when one or more incidents are sensed and reported to asset management system 175 and systems control package 180. This control information may include instructions on how to respond to a cross-function cascading failure affecting multiple different systems.

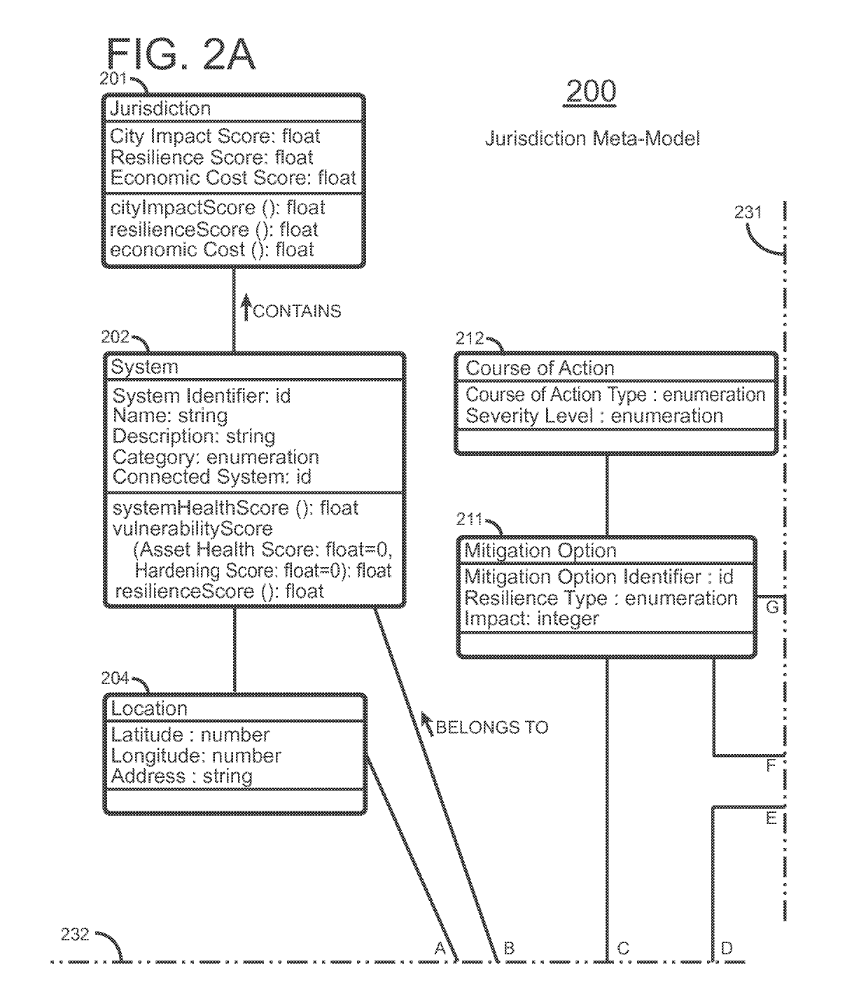

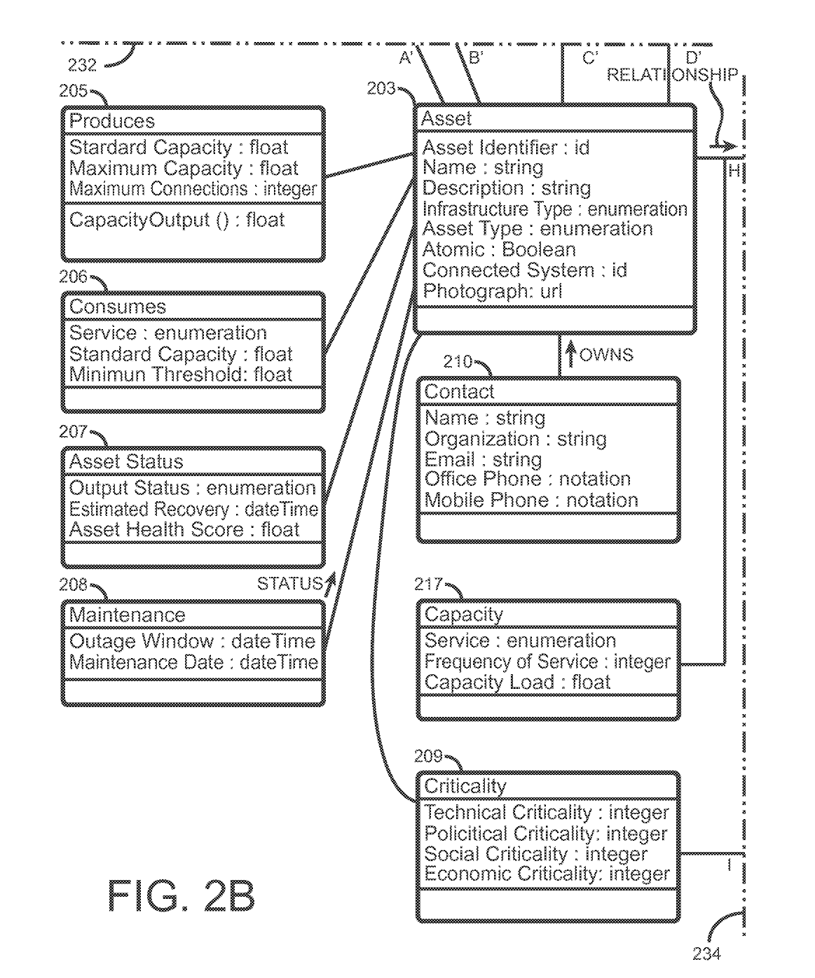

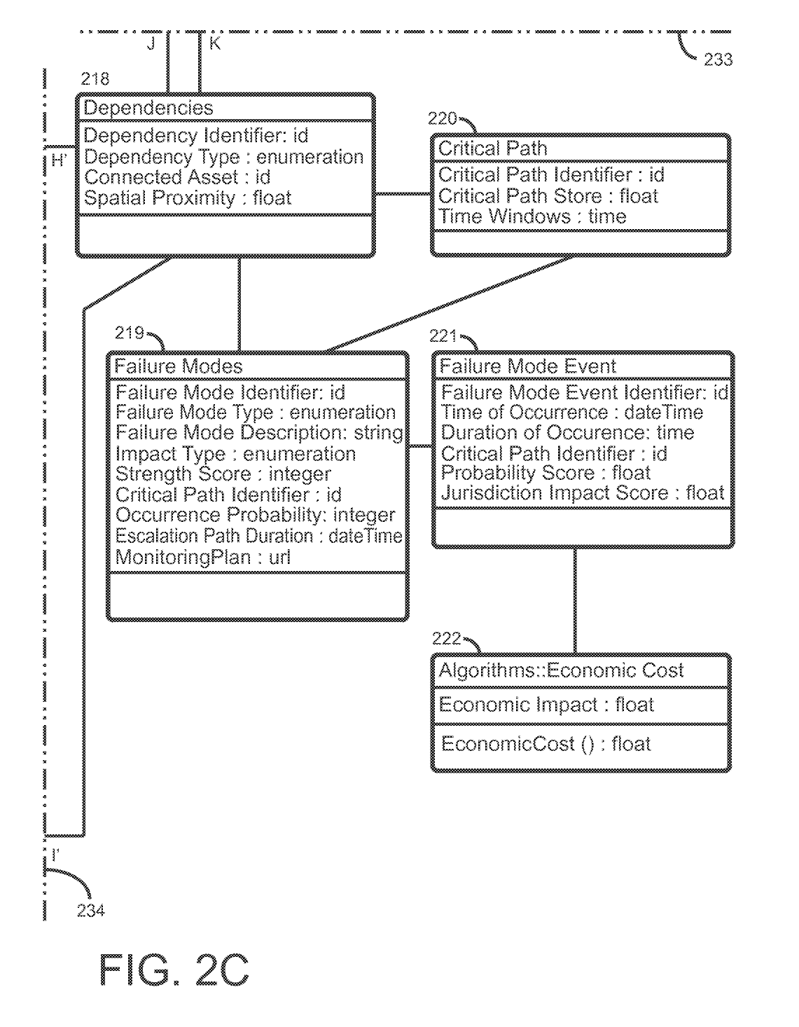

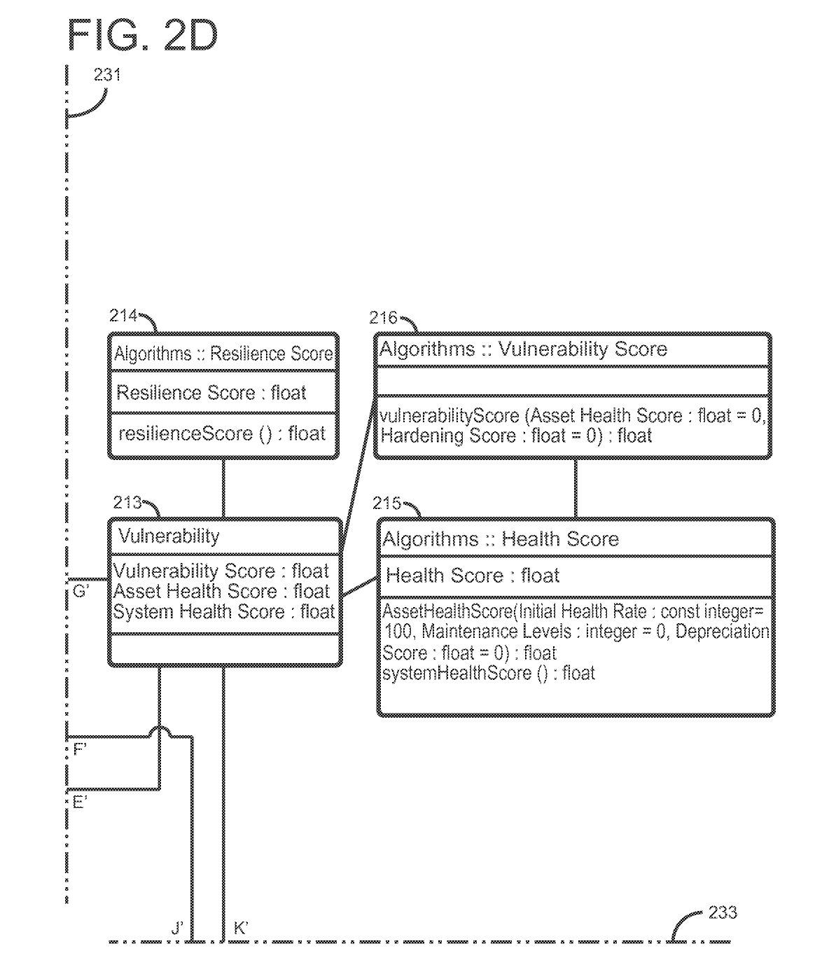

FIGS. 2A, 2B, 2C and 2D together show a representative jurisdiction meta-model 200 that the disclosed methodology may employ to model the system of systems that forms jurisdiction system 100. Before discussing meta-model 200 of FIGS. 2A-2D in detail, a number of definitions for terms employed by the model are first discussed. An asset is a component of a system. For example, traffic signal 120 is a component of traffic management system 160 that is an asset. Moreover, traffic signal 120 is a critical asset (designated CA17) of system 120 because failure of traffic signal 120 would be a critical failure of traffic management system 160. Other assets of traffic management system 160 include roads, bridges, and tunnels the conditions at which may be monitored via wired or wireless connections between the assets and the communication package 185.

By way of example, assets of electrical utility system 145 includes assets such as power substation 105, switchgear at the power substation, transformers and capacitors at the power substation, as well as overhead and underground electrical lines that form part of the jurisdiction system's electrical grid. Electrical utility system 145 includes asset status sensors (not shown) that sense operating conditions at these assets to determine their operational status and report that operational status back to communication package 185 which may be located at jurisdiction command center 170. Water utility system 150 includes assets such as water treatment plant 110, water mains, sewers, dams and weirs, for example. Water utility system 150 includes asset status sensors (not shown) that sense operating conditions at these assets to determine their operational status and report that operational status back to communication package 185.

By way of further example, healthcare system 155 includes assets such as hospital 115, clinics, on-premises back-up power generators, paramedic vehicles, ambulances and other assets. Healthcare system 155 includes asset status sensors (not shown) that sense operating condition at these assets to determine their operational status and report that operational status back to communication package 185.

The “health score” of an asset is determined by understanding maintenance requirements of the asset, the age of the asset, as well as failure rates of the asset. The health score of a system is calculated taking into consideration maintenance requirements of the entire system, the collection of assets which form that system, the age of the system and the observed failure rates of that system. In one embodiment, the health score is a number that indicates the relative health of a particular asset. For example, the number 100 may indicate maximum health while the number 0 they represent the lowest possible health of the asset. Asset status indicates the real time condition of a particular asset of a system.

FIGS. 2A, 2B, 2C and 2D join together as four quadrants to form the jurisdiction meta-model 200 wherein the jurisdiction is a city in this particular example. More specifically, these figures join together at dashed/dotted lines 231, 232, 233 and 234 to form jurisdiction metal model 200. The specific connections between the objects of the quadrants are given by A-A′, B-B′, C-C′, D-D′, . . . K-K′. Jurisdiction 100 is a collection of systems and assets of systems within a predefined area, such as a city.

Jurisdiction meta-model 200 includes a jurisdiction object 201 that includes a summary or top level object 201 that effectively represents the output of the whole meta-model. Jurisdiction object 201 includes a City Impact Score, a Resilience Score and an Economic Cost Score. The “float” designations in jurisdiction model 200 indicate floating point variables. The City Impact Score is a roll-up of all failure mode events of the jurisdiction system 100 into one score. A failure mode event is a failure in an asset of a system in jurisdiction system 100. The City Impact Score reflects a roll-up of the different systems of the city and the impact of failures in those systems into one score. The Economic Cost Score is a roll-up of the cost of failure mode events to the city. These costs are derived from the cost of failure mode events in the different systems of the city all rolled-up into one score. The Resilience Score in jurisdiction object 201 represents the total impact of mitigation options to reduce the cost of system failure within jurisdiction system 100. Mitigation options are alternative measures that may be taken to reduce risk to the systems of jurisdiction system 100, taking into consideration that an increase in asset or relationship availability results in an increase in impact.

Jurisdiction meta-model 200 includes a System object 202 that feeds Jurisdiction object 201 as indicated by the “CONTAINS” designator between these two objects. System object 202 includes a System Identifier:id that is unique for each system. For example, electrical utility system 145, water utility system 150, healthcare system 155 and traffic management system 160 each exhibit different unique identifiers. System object 202 includes a respective Name:string for each system, wherein the string describes in English or other language the name of the respective system, for example “City Healthcare”. Description:string may describe City Healthcare in more detail as Regional Healthcare Center. Category:enumeration indicates the category of the “City Healthcare” as a hospital. Category indicates the type of system. Connected System:id is an identifier that identifies dependencies of the particular system. Connected System:id indicates other systems to which a particular system is connected to and dependent on.

Referring now to asset object 203 of FIG. 2B, jurisdiction meta-model 200 includes an Asset object 203, wherein assets are the components that form systems. Each asset is represented by a respective unique Asset Identifier. The meta-model associates a Description:string with each Asset Identifier. By way of example, an Asset Identifier may be “49828” and the respective Description:string is a language string such as “power plant” or “transformer” that describes the particular asset. The Infrastructure Type:enumeration refers to the type of infrastructure that the asset involves. More particularly, the Infrastructure Type refers to the role a particular asset plays in the infrastructure of the system. For example, the Infrastructure Type may indicate that a particular asset is a response asset, a general infrastructure asset, or a backup asset. The Asset Type may describe the type of asset, for example “electrical distribution” in the case of a power plant, transformer, power line or capacitors. An Atomic descriptor is also associated with each asset. The Atomic descriptor indicates in Boolean fashion (Y, N) whether a particular asset is capable of being broken down further into sub-assets. For a power plant, the Atomic descriptor is Y to indicate that the power plant asset can be broken down into sub-assets such as transformers, capacitors, recloser switches and other switchgear and power distribution equipment. For a capacitor, the Atomic description is N to indicate that the capacitor may not be further broken down into other sub-assets. In Asset bock 203, Photograph:uri indicates that the meta-model stores a photograph that the user can view for a particular asset. In this manner, when an asset failure occurs, the user can drill down and view a photo of the particular failed asset. Asset object 203 also includes a Connected System:id that is the ID of another system on which the particular asset is dependent.

Returning now again to of FIG. 2A, System object 202 includes a Connected System:id that indicates if a particular system has a dependency on another system. The Connected System id indicates the ID of the other system on which the particular system is dependent. System object 202 of the meta-model further includes a systemHealthScore ( ):float, wherein this health score indicates how healthy the components of a system are at a particular point in time. For example, a generator of a power plant may need maintenance. If the generator currently needs maintenance, this may reduce the health score that has a max of 100 down to a smaller health score of 99, wherein 100 is a maximum health score and 0 is a minimum health score. Generators approaching end-of-life may have much smaller health scores such as 25, in one embodiment. System object 202 includes a vulnerabilityScore that indicates how redundant a particular asset is. Vulnerability indicates the risk or extent to which an asset or relationship is able to withstand the effects of a negative incident. The assets or relationships vulnerability is dependent on the number of weaknesses and health thereof. The vulnerability score is determined using the resilience score and asset health score, i.e. the health score of the asset or assets. Hardening Score is a score that indicates how hardened or redundant a particular system is. Higher hardening scores indicate that a system is less likely to fail. A resilience score is computed from impact of taking advantage of mitigation options, to reduce the risk and impact of system failures. Asset health scores show the current state of an asset, taking into account current maintenance issues, failure rates, system age, and other factors.

As shown in FIG. 2A, jurisdiction meta-model 200 includes a Location object 204. Location object 204 represents the location of an asset, for example the asset's latitude and longitude. Location object 204 may also represent and store the address of each asset as a respective string Address:string. Meta-model 200 may store a latitude, longitude and physical street address for each respective asset.

Referring now to FIG. 2B, meta-model 200 includes a Produces object 205. A particular asset such as the assets that asset object 203 represents may produce output that is to be consumed. The particular asset may exhibit a Standard Capacity:float and a Maximum Capacity:float. For example, where the particular asset is a generator, the Standard Capacity may be 1.5 MW and the Maximum Capacity may be 2.0 MW. The Produces object 205 also represents that the particular asset may support a Maximum Connections:integer, namely a maximum number of connections that the particular asset may supply or feed. Meta-model 200 represents different values for the Standard Capacity, Maximum Capacity, and Maximum Connection per asset. As seen in the meta-model 200 of FIG. 2B, Produces object 205 feeds all of this information into Asset object 203. Produces object 205 also includes capacityOutput ( ):float that is the current capacity at which the asset is operating. For example, if the asset is a transformer of a power substation, the current capacity output provided by the transformer may be 50 KW, namely the present capacity output. It may be possible to increase the capacity output above this level or reduce capacity output below this level.

Meta-model 200 includes a Consumes object 206. A particular asset such as the assets that asset object 203 represents may consume output from other assets. An asset can produce or consume or do both equally. In one embodiment, the meta-model employs a fixed list of service types to assure that like services are classified to the same service type. Each asset in meta-model 200 may have a respective service type associated with that asset. Consumes object 206 includes Service:enumeration that represents the service type of that each asset consumes. For example, a hospital consumes electrical power, and thus for a hospital asset, the Service:enumeration would be “electrical”. The hospital asset would also exhibit a Service:enumeration of “water” to designate the water resources that the hospital consumes. In Consumes object 206 of the meta-model, Standard Capacity:float represents that standard capacity that the hospital consumes, which for the hospital example could be a predetermined number of KW-H of electricity per day and a predetermined number of gallons of water per day. The Consumes object 206 also includes a Minimum Threshold:float that represents the minimum threshold of a consumable, such as electricity, water, gas or other consumable that the particular asset consumes.

Meta-model 200 also includes an Assets Status object 207 that indicates the real-time condition of an asset or system. In one embodiment, each system and asset in the meta model 200 of jurisdiction system 100 may have a respective Output Status:enumeration that indicates that the respective asset is fully functional, not functional, off-line but ready to go back on-line, or other output status. For those assets that are off-line or needing maintenance, the metal model employs Estimated Recovery:date Time, to indicate how long it will take to restore operation of the asset. The Asset Status object 207 of the meta-model also includes Asset Health Store:float to indicate respective operational health scores for each asset. The health score of an asset is derived using factors such as age of the asset, malfunction rate of the asset, maintenance of the entire system and maintenance of the collection of assets.

Meta-model 200 further includes a Maintenance object 208 that indicates when and how assets are maintained. On a per asset basis, Maintenance object 205 includes Outage Window:dateTime, namely the start and ending dates and times of when the asset is not functioning. Maintenance object 208 also includes the Maintenance Date:dateTime, namely the date and time that maintenance was performed on the asset on a per asset basis.

Meta-model 200 includes a Contact object 210 for each asset. For example, taking a power plant as one example, the power plant will have a manager or decision maker associated with the power plant. That person is the contact. The name of that person, Name:string is included in the Contact object 210. The contact object 210 also includes Organization:string to store the organization of the contact, Email:string to store the email address of the contact, Office Phone:notation to store the office phone number of the contact, and Mobile Phone:notation to store the mobile phone number of the contact.

Referring to FIG. 2C, meta-model 200 includes a Dependencies object 218 for each asset. For a particular asset, dependency Identifier:id is an identifier that indicates a single asset or multiple assets upon which the particular asset depends. The particular asset may be dependent on several other assets, and thus in this case the meta-model includes multiple dependency identifiers to identify those assets upon which the particular asset depends. A dependency identifier may be a numeric number that assists with linking between dependent assets. In Dependencies object 218, Dependency Types are categories for the kinds of systems on which an asset may be dependent. They include electrical power; fuel, which could be petrol, diesel oil, coal, piped natural gas or other fuels; water; external heating, e.g. metropolitan steam heat; as well as transportation related dependencies. In Dependencies object 218, Connected Asset:id specifies the ID of the actual asset to which a particular asset is dependent on and connected to. In Dependencies object 218, Spatial Proximity:float designates the distance between the two dependent assets taking into consideration the latitude and longitude of each of the two dependent assets.

Referring now to both FIGS. 2B and 2C, meta-model 200 shows a relationship connection between Asset object 203 and Dependencies object 218 with Capacity object 217 coupling into that relationship between Asset object 203 and Dependencies object 218. Capacities object 217 includes Service:enumeration that take into consideration the type of service feeding between two assets that are dependent on one another. Service:enumeration may be electrical service, water service, or other service. Capacity object 217 also includes Frequency of Service:integer to indicate how often service is required between the two assets, for example, once per day, once per hour, every 15 minutes, or other frequency. Capacity object 217 further includes Capacity Load:float that designates the actual load between the two dependent assets.

As seen in FIG. 2C, meta-model 200 includes a Critical Path object 220. Critical path is a path in which simulated or documented dependencies between assets indicate in high risk. For example, if you have a hospital with an intensive care unit (ICU) asset, then whatever assets are feeding the ICU, such as electrical lines and water lines, are designated as a critical path. The meta-model includes Critical Path Identifiers for such critical paths. The Critical Path object 220 also intrudes a Critical Path Score:float that indicates the level of criticality that the path exhibits. A high Critical Path Score indicates that the path is highly critical, whereas a low Critical Path Score indicates that the path is less critical. Critical Path object 220 also includes Time Windows:time that provides a time window for which it is predicted how long the critical path can stay alive before there is an actual failure.

FIG. 2B also shows that one embodiment of meta-model 200 includes a Criticality object 209 that represents the importance of maintaining operation of a particular asset. In Criticality object 209, Technical Criticality:integer represents how critical maintaining operation of a particular asset is from a technical viewpoint. In Criticality object 209, Political Criticality:integer represents how critical maintaining operation of a particular asset is from a political viewpoint. In Criticality object 9, Social Criticality:integer represents how critical maintaining operation of a particular asset is from a social viewpoint. In Criticality object 209, Economic Criticality:integer represents how critical maintaining operation of a particular asset is from an economic viewpoint.

Referring to FIG. 2C, in Failure Modes object 219, a failure mode is different from a failure mode event. A failure mode event is an actual incident that occurs such as a hurricane hitting a city and an actual occurrence of power outages. A failure mode refers to scenarios developed by individuals that demonstrate particular risks. Referring to Failure Modes object 219, this object includes a Failure Mode Identifier:id for a particular failure mode event. Failure Mode Type:enumeration may be a type such as extreme drought or heat. The Failure Mode Description:string provides a more detailed description of the particular failure mode. In Failure Mode object 219, Impact Type:enumeration refers to the evaluation of the jurisdiction's risk of failure ranging from no disruption to catastrophic damage. In Failure Mode object 219, Strength Score:integer is an integer that represents the intensity, i.e. strength, of a failure mode. For example, in the case where the Failure Mode is a tornado, the Strength Score may be the value 3. In the case where the Failure Mode is a hurricane, the Strength Score may be a 4. In Failure Mode object 219, Critical Path Identifier:id is an identifier that identifies the particular assets and dependencies impacted by the storm when a storm is the failure mode. For example, the Critical Path Identifier refers to the association of assets affected by the failure. The failure can be associated with a storm's path or the cascading failure impact due to system interactions and dependencies. In Failure Mode object 219, Occurrence Probability:integer is a number that indicates the probability that a particular event type will occur, for example a class 4 hurricane. In Failure Mode object 219, Escalation Path Duration: dateTime relates to how long an event is actually going to occur, for example the storm is going to take 40 minutes to pass through whereas the critical path may only be able to stay alive for 20 minutes or other time period. In other words, Escalation Path Duration relates to the timeframe (beginning & end time) of the failure mode occurrence. For instance, Escalation Path Duration relates to the storm surge starting and ending time. In Failure Mode object 219, Monitoring Plan:uri provides a link to a standard operating procedure for handling the particular failure mode. More particularly, Monitoring Plan relates to risk assessments, identified critical assets, communications, key health and performance indicators for scenarios that encompass known risks. The scenario assessments are identified, reviewed, and monitored continuously.

In Failure Mode Event object 221, the Failure Mode Event Identifier:id is an identifier that identifies an actual occurrence of an event such as a hurricane, tornado, flood, storm, earthquake or other failure mode event. In Failure Mode Event object 221, the Time of Occurrence:dateTime is the actual date and time of the particular failure mode event. The Duration of Occurrence:time is the actual time duration of the failure mode event. Failure Mode Event object 221 includes the Critical Path Identifier:id as already defined above. Probability Score:float refers to a real time determining of what impact the failure mode event will have such as for example on additional downstream assets. Jurisdiction Impact:score refers to a numerical impact store measuring the impact the failure mode event will have on the jurisdiction, which is this example is a city.

Jurisdiction meta-model 200 includes an Algorithms:Economic Cost object 222 that includes Economic Impact and Economic Cost. In one embodiment, jurisdiction system 100 may employ an economic cost tool to apply risk reduction measures to reduce economic cost which is selected and can be added to the jurisdiction system. Calculating a system and interaction of systems economic cost takes into consideration system criticality, systems interactions, probability of one or more event occurrences and cascading risks. By Economic Impact we mean the overall impact of an incident, including lost revenue, costs to recover, lost reputation, and other economic impact factors, expressed as a score ranging from 0-10, with 10 representing the greatest (worst) impact and 0 being the no impact. By Economic Cost we mean the direct financial cost to recover from an incident, due to clean up costs, repair costs and similar costs.

Returning now to FIG. 2A, jurisdiction model 200 includes a Mitigation Option object 211 that includes a Mitigation Option Identifier, Resilience Type and Impact. With respect to Mitigation Option object 211, there are different mitigation procedures that are alternative measures to decrease risk to the jurisdiction system or systems thereof. For example, mitigation options may include adding backup assets to a particular asset, replacing a particular asset with a more robust asset, and other mitigation options. The Mitigation Option Identifier of Mitigation Option object 211 identifies a particular mitigation for a particular asset. Different assets will have different mitigation option identifiers in the jurisdiction meta-model 200. The Resilience Type of Mitigation Option 211 refers to the type of resilience the mitigation option is trying to increase or recover. This includes but is not limited to increase/recover redundancy, or increase/recover assets in a system such as protective infrastructure (levees, sea walls, shelters), infrastructure redundancy (backup asset, dual), structural safety, and interoperability (inter-agency compatibility, shared systems).

A seen in FIG. 2A, jurisdiction meta-model 200 includes a Course of Action object 212 that provides different courses of action that can be taken prior to an event, i.e. incident, during the event, or after the event. Course of Action object 212 includes Course of Action Type:enumerate that indicates different descriptions that indicate where the mitigation option is needed for a long term or is the mitigation option is needed to the reduce impact of the event immediately. For example, there are different mitigation option types according to whether the user desires to prevent an incident, react to an incident or perform a long term recovery from an incident. Course of Action object 212 includes Impact that is a measure of effectiveness, including the assessment of impact that each potential change has on the desired effect to reduce vulnerability. This allows for the identification of the combination of mitigation options that cause the probability of a desired effect above a certain threshold.

Turning now to FIG. 2D, meta-model 200 includes a Vulnerability object 213. Vulnerability object 213 includes a Vulnerability Score, an Asset Health Score, and System Health Score. Meta-model 200 includes an Algorithms::Resilience Score object 214 that provides respective resilience scores for assets and systems to vulnerability object 213. Meta-model 200 includes an Algorithms::Vulnerability Score that indicates how vulnerable particular assets are to incidents. Each asset may have a respective Vulnerability Score that indicates how susceptible that asset is to incidents. Dependencies of an asset on another assets or assets is a factor in determining the Vulnerability Score of an asset. The Vulnerability Score of Algorithms:Vulnerability Score object 216 feeds into Vulnerability object 213. The Vulnerability Score may be a composite of asset health, i.e an Asset Health Score and hardening (i.e. Hardening Score) exhibited by a particular asset as per Vulnerability Score object 216. The Asset Health Score is determined in Algorithms: Health Score object 215. Each asset may exhibit a respective Asset Health Score in meta-model 200. Algorithms::Health Score object 215 provides Asset Health Scores for respective assets that feed into the Vulnerability object 213. The Vulnerability object 213 feeds into Asset object 203 which feeds into System object 202 which in turn feeds into Jurisdiction object 201. In this manner, vulnerability information with respect to assets and systems is fed into system object 202 and in turn up to jurisdiction object 201.

In one embodiment, asset management package 175 of FIG. 1B may store a catalog of potential interactions between systems 145-160 when incidents occur. Systems control package 180 enables control of responses to cascading failures across different systems at times post incident. Systems control package 180 may access standard operating procedures determined in advance for incidents affecting multiple systems, i.e. cross-systems incidents. At a high level, the following summarizes steps that jurisdiction command center 170 may employ for handling incidents. Prior to an incident, the meta-model 200 is formed as described above taking into consideration cross-system dependencies and cascading failures across the multiple systems 145-160 that are part of jurisdiction system 100. Prior to the incident, all assets of the respective system are identified and represented in meta-model 200. Critical assets are identified and represented in the meta-model. The role of each asset is identified and represented in the meta-model. The consequences of each asset not functioning are identified and represented in the metal model. Critical paths are identified and represented in the meta-model. The meta-model may link to standard operating procedures to take in the event of cross-systems failures. The meta-model may link to standard operating procedures to take in the event of cascading failures across systems. When an incident occurs, sensors within jurisdiction system 100 detect the incident or the incident may be alternatively manually observed and reported to the jurisdiction system 100. In response to the incident, a user at jurisdiction command center 170 may implement a standard operating procedure response strategy that metal-model 200 suggests to ameliorate the effects of a cross system failure such as cascading failures across the multiple different systems of the jurisdiction system.

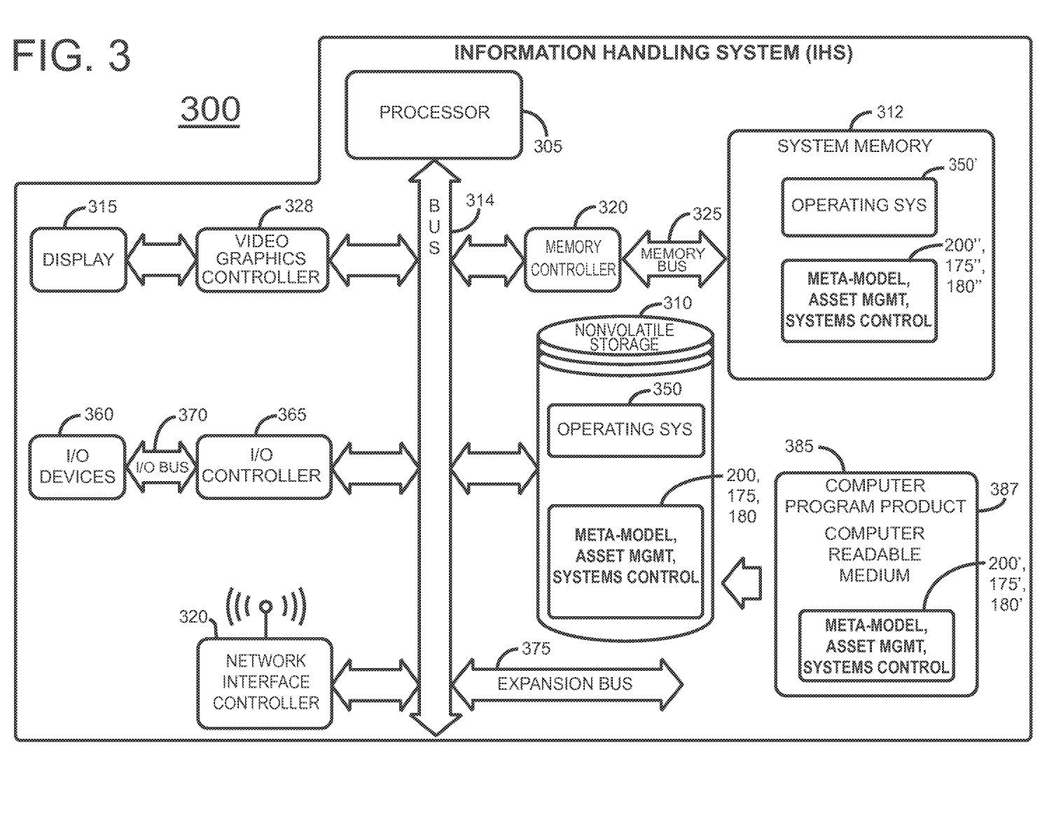

FIG. 3 is a block diagram of an information handling system that may be employed as information handling system (IHS) 300 to practice the disclosed methodology. IHS 300 includes a processor 305 that may include multiple cores. IHS 300 processes, transfers, communicates, modifies, stores or otherwise handles information in digital form, analog form or other form. IHS 300 includes a bus 314 that couples processor 305 to memory 312 via a memory controller 320 and memory bus 325. System memory 312 may also be referred to as main memory. System memory 312 may be a static random access memory (SRAM) array or a dynamic random access memory (DRAM) array. Processor 305 may also include local memory such as L1, L2 and L3 caches. A video graphics controller 328 couples display 315 to bus 314. Nonvolatile storage 310, such as a hard disk drive, solid state drive (SSD), CD drive, DVD drive or other nonvolatile storage couples to bus 314 to provide IHS 300 with permanent storage of information. System memory 312 and nonvolatile storage 310 are both forms of memory stores. Nonvolatile storage 310 stores an operating system 350 (OPERATING SYS) that governs operation of IHS 300.

In one embodiment, nonvolatile storage 310 also stores meta-model 200, asset management package 175 and systems control package 180. While FIG. 3 depicts IHS 300 as including meta-model 200, asset management package 175 and systems control package 180 in the same IHS, in other embodiments meta-model 200, asset management package 175 and systems control package 180 may be in physically different IHS locations that are logically connected and communicate with one another. Nonvolatile storage 310 may also store one or more other applications that processor 305 executes. I/O devices 360, such as a keyboard and a pointing device, couple to bus 314 via I/O controller 365 and I/O bus 370.

One or more expansion busses 375, such as USB, IEEE 1394 bus, ATA, SATA, PCI, PCIE, DVI, HDMI and other busses, couple to bus 314 to facilitate the connection of peripherals and devices to IHS 300. A network interface controller (NIC) 320 couples to bus 314 to enable IHS 300 to connect by wire or wirelessly to a network and/or other information handling systems. Network interface controller 320 may also be called a network communication adapter or a network adapter. While FIG. 3 shows one IHS that employs processor 305, the IHS may take many forms. For example, IHS 300 may take the form of a desktop, server, portable, laptop, notebook, tablet, or other form factor computer or data processing system. IHS 300 may take other form factors such as a gaming device, a personal digital assistant (PDA), a portable telephone device, a communication device or other devices that include a processor and memory.

In one embodiment, IHS 300 employs computer program product 385 that includes meta-model 200′, asset management package 175′, and system control package 180′ stored on a computer readable medium 387 such as a CD, DVD, flash drive or other media. In one embodiment, meta-model 200′, asset management package 175′, and system control package 180′ may be stored on separate respective computer readable media. In actual practice, a user or other entity may load meta-model 200′, asset management package 175′, and system control package 180′ in non-volatile storage 310 as meta-model 200, asset management package 175, and system control package 180. When IHS 300 initializes, the IHS loads meta-model 200, asset management package 175, and system control package 180 and operating system 350 into system memory 312 for execution as meta-model 200″, asset management package 175″, system control package 180″ and operating system 350′.

As will be appreciated by one skilled in the art, aspects of the disclosed methodology may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to illustrations showing objects and/or block diagrams of methods, apparatus (systems) and computer program products according to embodiments of the invention. It will be understood that the objects or blocks of FIG. 2A-2D and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the objects of FIG. 2A-2D and/or illustrated in a block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the objects of FIG. 2A-2D described above.

The objects of FIG. 2A-2D illustrate the architecture, functionality, and operation of possible implementations of systems, methods and computer program products that perform analysis in accordance with various embodiments of the present invention. In this regard, each object of FIG. 2A-2D may represent a module, segment, or portion of code, which comprises one or more executable instructions for implementing the specified logical function(s). It should also be noted that, in some alternative implementations, the functions noted in the block may occur out of the order noted in the objects of FIG. 2A-2D. For example, two objects shown in succession may, in fact, be executed substantially concurrently, or the blocks may sometimes be executed in the reverse order, depending upon the functionality involved. It will also be noted that each of the objects of FIG. 2A-2D and combinations of blocks in the block diagrams other illustrations, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1-7. (canceled)

8. An information handling system (IHS), comprising:
a processor:
a system memory coupled to the processor, the system memory being configured to:
determine multiple different systems of a jurisdiction;
determine assets of the multiple different systems;
store, in a jurisdiction meta-model, asset information describing the respective assets of the multiple different systems;
determine critical paths across the different systems of the jurisdiction and identify those critical paths across different systems in the jurisdiction meta-model;
determine cascading effects of incidents to assets within each system and identify those cascading effects within each system in the jurisdiction meta-model; and
determine cross-cascading effects of incidents to assets across different systems of the jurisdiction and identify those cross-cascading effects in the jurisdiction meta-model.

9. The IHS of claim 8, wherein the system memory is configured to determine cross-system dependencies associated with assets of the multiple different systems.

10. The IHS of claim 8, wherein the system memory is configured to sense an incident, and in response to sensing the incident, access the jurisdiction meta-model to determine cross-cascading effects associated with the incident.

11. The IHS of claim 8, wherein the system memory is configured to determine a resilience score for the jurisdiction for the assets identified in the multiple different systems of the jurisdiction meta-model.

12. The IHS of claim 8, wherein the system memory is configured to determine a jurisdiction impact score for the jurisdiction by accessing the jurisdiction meta-model.

13. The IHS of claim 8, wherein the system memory is configured to link responsive operating procedures to the jurisdiction meta-model to provide response plans in the event of an incident that causes cross-cascading effects.

14. The IHS of claim 8, wherein the system memory is configured to identifying in the jurisdiction meta-model assets that are producers and assets that are consumers both within systems and across different systems.

15. A computer program product, comprising:
a non-transitory computer readable storage medium;
first instructions that determine multiple different systems of a jurisdiction;
second instructions that determine assets of the multiple different systems;
third instructions that store, in a jurisdiction meta-model, asset information describing the respective assets of the multiple different systems;
fourth instructions that determine critical paths across the different systems of the jurisdiction and that identify those critical paths across different systems in the jurisdiction meta-model;
fifth instructions that determine cascading effects of incidents to assets within each system and that identify those cascading effects within each system in the jurisdiction meta-model, and
sixth instructions that determine cross-cascading effects of incidents to assets across different systems of the jurisdiction and that identify those cross-cascading effects in the jurisdiction meta-model;
wherein the first, second, third, fourth, fifth and sixth instructions are stored on the non-transitory computer readable storage medium.

16. The computer program product of claim 15, further comprising seventh instructions that determine cross-system dependencies associated with assets of the multiple different systems.

17. The computer program product of claim 15, further comprising eighth instructions that sense an incident, and in response to sensing the incident, access the jurisdiction meta-model to determine cross-cascading effects associated with the incident.

18. The computer program product of claim 15, further comprising ninth instructions that determine a resilience score for the jurisdiction for the assets identified in the multiple different systems of the jurisdiction meta-model.

19. The computer program product of claim 15, further comprising tenth instructions that determine a jurisdiction impact score for the jurisdiction by accessing the jurisdiction meta-model.

20. The computer program product of claim 15, further comprising eleventh instructions that link responsive operating procedures to the jurisdiction meta-model to provide response plans in the event of an incident that causes cross cascading effects.
